(19) United States
(12) Patent Application Publication
(10) Pub. No.: US 2007/0258254 A1
(43) Pub. Date: Nov. 8, 2007

(54) Lightening apparatus for rotators

(76) Inventor: Wha Shik Kim, Seongnam City (KR)

Correspondence Address: Sangdaewon-dong, Jungwon-gu, #708 Kranz Techno, 5442-1, Seongnam-si, Kyeonggi-do, KR

(21) Appl. No.: 11/418,166

(22) Filed: May 5, 2006

(51) Int. Cl. B62J 6/00

(52) U.S. Cl. 362/473

(57) ABSTRACT

A lightening apparatus, taking advantage of rotating shaft of a bicycle wheel, is provided. The lightening apparatus of the current application is comprised of an AC(alternating current) electricity generator, two sets of pluralities of LEDs (light emitting diodes) are immobilized inside of a rotating lightening case and connected with electric wires, and a rotating connector. The AC generator is attached inside of an immobilized cover, which is fixed to a non-rotating shaft of a bicycle wheel. The rotating lightening case is fixed to a rotating shaft of a bicycle wheel. The rotating connector is placed inside of a rotating annular disc that is fixed to the rotating shaft of a bicycle. The LEDs immobilized on the lightening case of the current application blinks as the wheel of the bicycle turns.

### BACKGROUND OF THE INVENTION

1. Field of the Invention

Current application is related with a lightening apparatus for rotating bodies, especially for wheel of a bicycle and motor bicycles.

2. Description of the Prior Art

Korean Patent 493,067 to Yoo illustrates an\lightening apparatus for rotating wheel of a bicycle. An immobilized plate, which is equipped with a main gear, is fixed to a non-rotating shaft of a wheel of a bicycle. A rotating plate is attached to a rotating shaft. An electricity generator, equipped with an induced gear, is fixed to the rotating plate. The induced gear of the electric generator is engaged to the main gear, which is fixed to the immobilized plate. As the wheel rotates, the induced gear of the generator rotates to generate electricity. Pluralities of LEDs (Light Emitting Diodes) are located on the inner side of a rim of a wheel. A connecting tube is placed between the electricity generator and the rim of the wheel. Lead wires are embedded inside of the connecting tube.

However, pluralities of holes should be developed along the inside of the rim of the wheel for those pluralities of LEDs. Such holes deteriorate the strength of the wheel and may cause safety problems. In addition to that, several additional steps of; punching the pluralities of holes, installing connecting tube, and inserting and adhering LEDs to the outer surface of the rim are needed. Such additional process lowers the productivity of manufacturing a bicycle.

Moreover, when inserting and fixing an LED to one of the holes on the rim, the lead wire is connected to the LED and the connected point is wrapped with flexible plastic tape to prevent the wire from exposing to the tire to make a hole. The connection point is easily released by the pressure of the tire and disconnected by tools while changing the tire.

Korean patent application by KIM 2005-135431 illustrates a lightening apparatus for rotating wheel of a bicycle. An immobilized cover is fixed to a non-rotating shaft and a rotating cover is fixed to a rotating shaft. An electricity generator is fixed inside of the rotating cover. An induced pulley is attached to the shaft of the electricity generator and a main pulley is developed on the outer side of the immobilized cover. Those two pulleys are contacted directly or connected by a belt having pluralities of embossing developed thereon. A ring shape light emitting case, with pluralities of LED holes, is installed on the rotating shaft. Pluralities of LEDs are located inside of the light emitting case and inserted to the LED holes. A connecting tube is placed inside of the rotating shaft to receive electricity wire that connects the electricity generator and the LEDs. However, a fixed case of large diameter is needed to cover the radius of the rotating electricity generator that is fixed on the rotating cover. And the light emitting case is designed very hard to assemble the LEDs therein.

None of the prior art illustrates a lightening apparatus for rotating shaft of a bicycle wheel that is easy to assemble and install to the wheel.

### SUMMARY OF THE INVENTION

A lightening apparatus, taking advantage of rotating shaft of a bicycle wheel, is provided. The lightening apparatus of the current application is comprised of an AC (alternating current) electricity generator, two sets of pluralities of LEDs (light emitting diodes) placed inside of a rotating lightening case and connected with electric wires, and a rotating connector. The AC generator is attached inside of an immobilized cover, which is fixed to a non-rotating shaft of a bicycle wheel. The rotating lightening case is fixed to a rotating shaft of a bicycle wheel. The rotating lightening case is in a shape of a valve knob with 8 protrusions. The rotating lightening case is divided into four part to make it easy to attach the cover to the rotating wheels and install and replace LEDs inside thereof. The rotating connector is placed inside of a rotating annular disc that is fixed to the rotating shaft of a bicycle. Lead wires form the electricity generator and another lead wire from the LEDs are rotatably connected to the rotating connector. The LEDs in the lightening case of the current application blinks as the wheel of the bicycle turns. Due to the structure of the rotating lightening case of the current application, it is easy to install the lightening apparatus to the wheel of a bicycle and the assembling time is shortened. Due to the stable position of the AC electricity generator in the fixed cover, the noise is reduced drastically. The productivity of assembling the apparatus and the stability is enhanced at the same time.

### BRIEF DESCRIPTION OF THE DRAWINGS

FIG. 1 is a perspective view of a bicycle wheel of the current application.

FIG. 2 is an exploded perspective view of the lightening apparatus of the current application.

FIG. 3 is a cross-sectional view of the lightening apparatus of the current application focused on the immobilized cover.

FIG. 4 is a perspective view of the lightening case of the current application.

FIG. 5 is an exploded perspective view of the lightening case of the current application.

FIG. 6. is an example of the lightening apparatus of the current application installed on a bicycle.

FIG. 7 is another embodiment of the array of the LEDs according to the current application.

### DETAILED DESCRIPTION OF THE PREFERRED EMBODIMENT

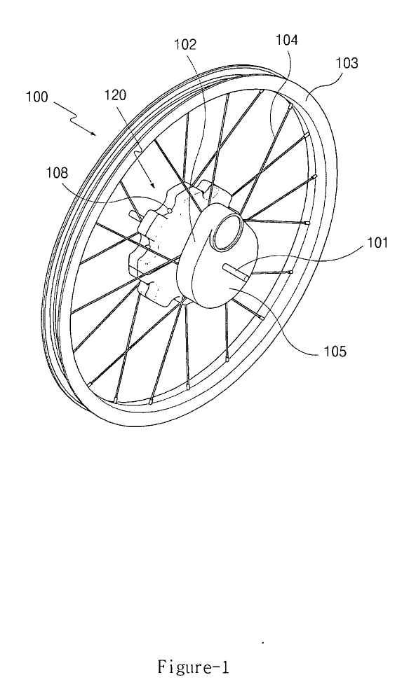

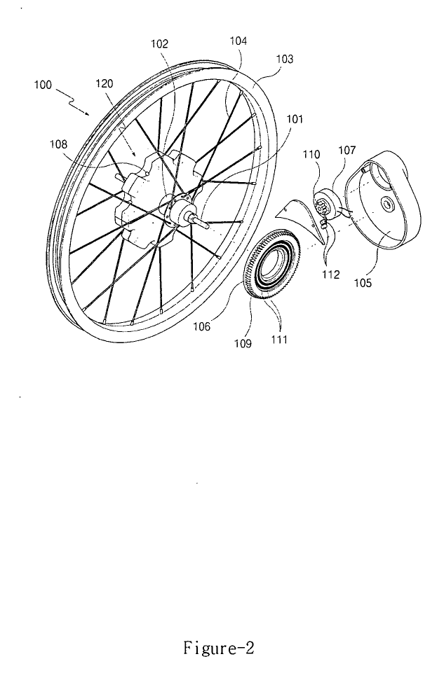

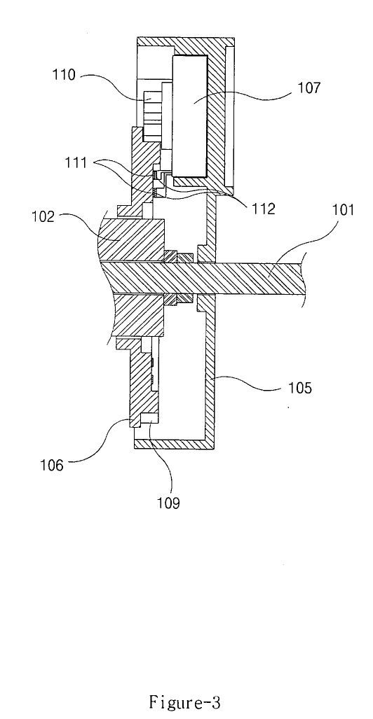

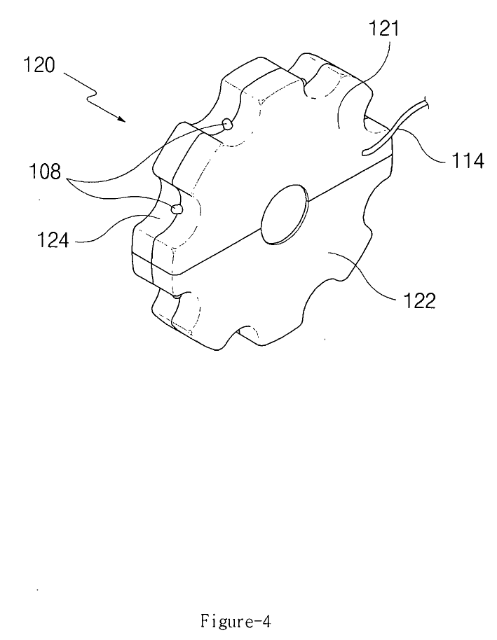

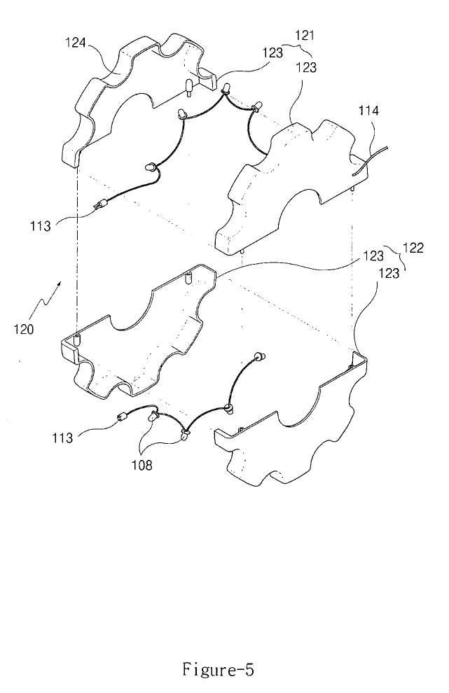

Referring to FIG. 1 to FIG. 5, the wheel (100) is engaged to the body of a bicycle by the non-rotating shaft (101). A rotating shaft (102) is installed radial outside of the non-rotating shaft (101). Rim (103) of a wheel is connected to the radial out side of the rotating shaft (102) via pluralities of spokes (104) in a zigzag pattern. A cam shape immobilized cover (105) is fixed to the non-rotating shaft (101). A rotating annular disc (106) is engaged to one side, which is close to the immobilized cover (105), of the rotating shaft (102). An electricity generator (107) is placed inside of the cam shape immobilized cover (105) at the position of the tip of the cam. A rotating lightening case (120) is engaged to the rotating shaft (102). The lightening case (120) is located between the rotating shaft (102) and the rim (103) of the wheel within a space formed by the zigzag arranged spokes (104).

Main gear (109) is developed along the outer surface of the rotating annular disc (106) and an induced gear (110) is fixed to a shaft of the AC electricity generator (107).

Two ring connectors (111), having common center at the rotating shaft (102), are formed inside of the rotating annular disc (106). Two electricity out put connectors (112) from the AC electricity generator (107) are electrically connected to the ring connectors (111).

The lightening case (120) is in a shape of a valve knob with 8 protrusions. Surface of the lightening case is coated with a silver metal like paint. The lightening case (120) is divided into front part and rear part. The front part and rear parts are again divided into upper part (121) and lower part (122). Then, the lightening case is divided into four pieces (123) of a same shape. Two electric circuits having eight LEDs (108) on one lead line are prepared. Each circuit is immobilized on a half case that is comprised of two pieces (123). LEDs (108) on the two electric circuits are connected together by a connector (113). A lead wire (114) is extended from one of the circuit and connected to the ring connector (111).

Light reflecting grooves (124) are developed on concave surface formed between the protrusions.

The lightening apparatus of the current application operates as follows:

When a rim (103) rotates, the rotating shaft (102), which is connected to the rim via spokes (104), turns. Then the rotating annular disc (106), which is connected to the rotating shaft (102), turns. Then the main gear, developed radially on the outer surface of the rotating annular disc (1 06), turns the induced gear (110) that is fixed to the shaft of the AC electricity generator (107) and generates electricity.

Electric currents flows to the ring connectors (111) through the two electricity output connectors (112) while maintain contacting position though the ring connectors rotates. The electricity, then, passes through the ring connectors (111) and flows into lead wire (114) to reach to the LEDs (108).

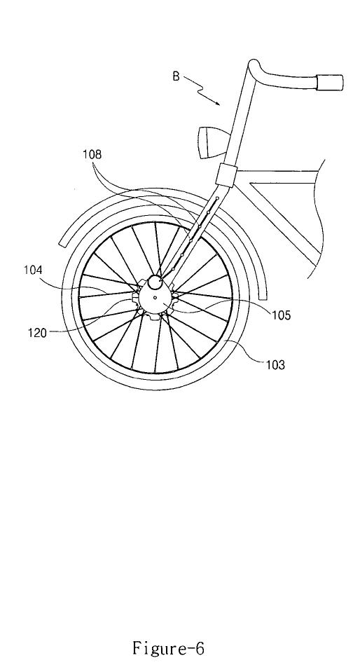

The electricity output connectors (112) can be extended to other direction shown as in FIG. 6. The structure of the lightening apparatus for rotating body has smaller size than the prior art.

Another embodiment of the current application is that the LEDs (108) are inserted to holes that are formed by combining the two pieces (123) and press the half case (121) or (122) while they are hot just after come from mold. Then no other additional steps for inserting the LEDs are needed.

Each half case (121) and (122) are connected by male and female connector developed on each of the half case.

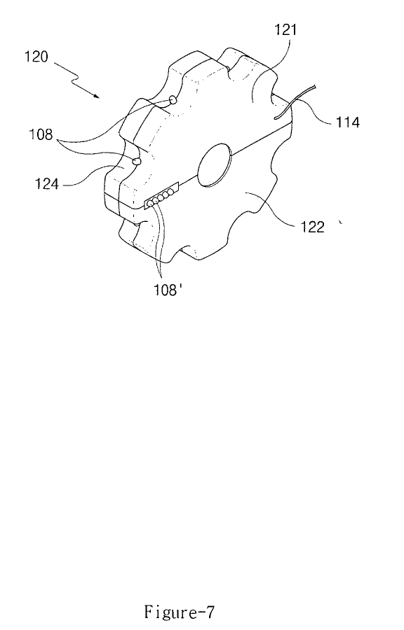

FIG. 7 is another layout of LEDs (108) arranged in a straight line radially from the rotating shaft (102) of the wheel on each side face of the lightening case (120).

What is claimed is:

1. A lightening apparatus for rotators, taking advantage of rotating shaft of a bicycle wheel, is comprised of;
an AC (alternating current) electricity generator that has an induced gear that is fixed to a shaft of the AC electricity generator and has two electricity out put connectors and that is attached at the position of the inside tip of the cam of a cam shape immobilized cover, which is fixed to a non-rotating shaft of a bicycle wheel, and
two sets of pluralities of LEDs (light emitting diodes), each set is connected on one electric wire, which are connected in one line via an electric connectors and immobilized inside of a rotating lightening case that is in a shape of a valve knob with 8 protrusions and has 8 holes for exposing the LEDs to the concave surface formed between the protrusions and that is fixed to a rotating shaft of a bicycle wheel between the rotating shaft and the rim of the wheel within a space formed by the zigzag arranged spokes, and
two rotating ring connectors which have common center at the rotating shaft and are placed inside of a rotating annular disc that has a main gear developed along the outer surface thereof and is engaged to one side of the rotating shaft, which is close to the immobilized cover, and is fixed to the rotating shaft of a bicycle and connects the two electricity out put connectors from the AC electricity generator and one lead wire extended from the lightening case.

2. A lightening apparatus for rotators of claim 1, wherein;
the lightening case is divided into front part and rear part, which are again divided into upper part and lower part to form four pieces of a same shape and
two electric circuits, each of which has pluralities of LEDs on one lead line and is immobilized on a half case that is comprised of two pieces of the four parts, are connected together by an electric connector and
one lead wire is extended from one of the circuits and connected to the ring connector and
pluralities of LEDs are arranged in a straight line radially from the rotating shaft of the wheel on each side face of the lightening case.
